(19) United States
(12) Patent Application Publication
(10) Pub. No.: US 2025/0246155 A1
(43) Pub. Date: Jul. 31, 2025

(54) DISPLAY DEVICE AND METHOD OF DRIVING SAME

(71) Applicant: LG Display Co., Ltd., Seoul (KR)

(72) Inventors: Ui Taek JEONG, Paju-si (KR); Moo Kyoung HONG, Paju-si (KR)

(21) Appl. No.: 18/952,471

(22) Filed: Nov. 19, 2024

(30) Foreign Application Priority Data
Jan. 31, 2024 (KR) 10-2024-0015260

(51) Int. Cl. G09G 3/3275; G09G 3/3233

(52) U.S. Cl. CPC G09G 3/3275; G09G 3/3233; G09G 2300/0842; G09G 2310/0286; G09G 2310/08; G09G 2320/0233

(57) ABSTRACT

Disclosed is a display device including a display panel including subpixels, and a data driver connected to the display panel, wherein the data driver outputs data voltages for displaying an image on the basis of the subpixels during a driving period of the display panel, and outputs a first data voltage, a second data voltage having a level different from the first data voltage, and a third data voltage having a level different from the second data voltage during a sensing period of the display panel.

### CROSS-REFERENCE TO RELATED APPLICATION(S)

This application claims the benefit of Korean Patent Application No. 10-2024-0015260, filed on Jan. 31, 2024, which is hereby incorporated by reference as if fully set forth herein.

### BACKGROUND

### Technical Field

The present disclosure relates to a display device and a method of driving the same.

### Description of the Related Art

As information technology develops, the market for display devices, which are communication media between users and information, is growing. Accordingly, display devices such as a light emitting display (LED) device, a quantum dot display (QDD) device, and a liquid crystal display (LCD) device are increasingly used.

The display devices described above include a display panel including subpixels, a driver outputting driving signals for driving the display panel, and a power supply for generating power to be supplied to the display panel or the driver.

In such display devices, when driving signals, for example, a scan signal and a data signal, are supplied to subpixels formed in a display panel, selected subpixels transmit light or directly emit light, thereby displaying an image.

### BRIEF SUMMARY

Accordingly, the present disclosure is directed to a display device and a method of driving the same that substantially obviate one or more problems due to limitations and disadvantages of the related art.

Embodiments of the present disclosure mitigate or alleviate problems caused by the difference between a recovery data voltage and a display data voltage applied to the next frame during a sensing period (or blank period) for sensing deterioration of elements included in a subpixel. In addition, embodiments of the present disclosure minimize or improve the coupling phenomenon between different voltages and problems caused by overcompensation and undercompensation depending on luminance. Further, embodiments of the present disclosure minimize or improve problems that sensing lines are visible or luminance differences (including luminance reduction) occur.

Additional advantages, objects, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

To achieve these objects and other advantages and in accordance with the purpose of the present disclosure, as embodied and broadly described herein, a display device includes a display panel including a plurality of subpixels, and a data driver connected to the display panel, wherein the data driver, in operation, outputs a plurality of data voltages for displaying an image based on the subpixels during a driving period of the display panel, and outputs a first data voltage, a second data voltage, and a third data voltage during a sensing period of the display panel, wherein a level of the first data voltage is different from a level of the second data voltage, and wherein the level of the second data voltage is different from a level of the third data voltage.

In another aspect of the present disclosure, a display device includes a display panel including subpixels, and a data driver connected to the display panel, wherein the data driver, in operation, sequentially outputs a first data voltage, a second data voltage, and a third voltage through a data line connected to the display panel during a blank period, wherein a level of the first data voltage is different from a level of the second data voltage, and wherein the level of the second data voltage is different from a level of the third data voltage.

By way of example, the level of the second data voltage is equal to or higher than a level of a display data voltage applied to a sensing target subpixel during a previous frame.

By way of example, the level of the third data voltage is between the level of the second data voltage and a level of a display data voltage to be applied to a sensing target subpixel during a next frame.

By way of example, the first data voltage is as a sensing data voltage for sensing a sensing target subpixel during the sensing period of the display panel, the second data voltage is a recovery data voltage that compensates for a decrease in luminance of the sensing target subpixel during the sensing period of the display panel, and the third data voltage is a buffering data voltage that reduces a difference between a display data voltage to be applied to the sensing target subpixel during the sensing period of the display panel and a display data voltage to be applied to the sensing target subpixel during the next frame.

By way of example, the first data voltage, the second data voltages, and the third data voltage form a step voltage having a level that gradually increases in a step shape.

By way of example, the third data voltage varies in response to a level of a display data voltage to be applied to a sensing target subpixel.

In another aspect of the present disclosure, a method of driving a display device includes outputting a plurality of data voltages for displaying an image based on a plurality of subpixels during a driving period of a display panel, outputting a first data voltage for sensing a sensing target subpixel during a sensing period of the display panel, outputting a second data voltage that compensates for a decrease in luminance of the sensing target subpixel during the sensing period of the display panel, and outputting a third data voltage that reduces a difference between a level of a data voltage to be applied to the sensing target subpixel during the sensing period of the display panel and a level of a data voltage to be applied to the sensing target subpixel during a next frame.

By way of example, the first data voltage, the second data voltage, and the third data voltage form a step voltage having a level gradually increasing in a step shape.

By way of example, the third data voltage is varied in response to a level of a display data voltage to be applied to the sensing target subpixel.

It is to be understood that both the foregoing general description and the following detailed description of the present disclosure are exemplary and explanatory and are intended to provide further explanation of the present disclosure as claimed.

### BRIEF DESCRIPTION OF THE SEVERAL VIEWS OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram schematically showing a light emitting display device, FIG. 2 is a configuration diagram schematically showing a subpixel shown in FIG. 1, and FIG. 3 is a diagram illustrating a pixel composed of subpixels;

FIG. 4 and FIG. 5 are diagrams illustrating the configuration of a gate-in-panel type gate driver, and FIG. 6 is a diagram showing an example of the arrangement of the gate-in-panel type gate driver;

FIG. 7 is a diagram schematically showing a subpixel and a data driver according to a first example of an embodiment, FIG. 8 is a diagram schematically showing a subpixel and a data driver according to a second example of the embodiment, and FIG. 9 is a waveform diagram illustrating a sensing period and a display period according to the embodiment;

FIG. 10 is a diagram showing some of components included in the data driver according to the embodiment in more detail, and FIG. 11 and FIG. 12 are diagrams showing a method of sensing a display panel according to the embodiment;

FIG. 13 is a timing diagram schematically illustrating a method of driving a light emitting display device according to an embodiment, FIG. 14 is a first example diagram showing data voltages applied to a sensing subpixel in the N-th frame shown in FIG. 13, and FIG. 15 is a second example diagram showing data voltages applied to the sensing subpixel in the N-th frame shown in FIG. 13;

FIG. 16 is a timing diagram illustrating the method of driving a light emitting display device according to the embodiment in more detail, FIG. 17 is a diagram illustrating a sensing voltage obtained through sensing illustrated in FIG. 16, FIG. 18 to FIG. 21 are diagrams showing step-by-step operations of main devices according to the driving method shown in FIG. 16, and FIG. 22 is a diagram illustrating differences depending on whether or not a buffering data voltage is applied; and

FIG. 23 is a flowchart illustrating a method of configuring a buffering data voltage according to an embodiment, and FIG. 24 and FIG. 25 are diagrams showing a buffering data voltage that varies based on the level of a display data voltage applied to the next frame according to an embodiment.

### DETAILED DESCRIPTION

A display device according to the present disclosure may be implemented as a television system, an image player, a personal computer (PC), a home theater, an automobile electric device, a smartphone, or the like, but is not limited thereto. The display device according to the present disclosure may be implemented as a light emitting display (LED) device, a quantum dot display (QDD) device, a liquid crystal display (LCD) device, or the like. However, for convenience of description, as an example, a light emitting display device that directly emits light based on inorganic light emitting diodes or organic light emitting diodes will be described below.

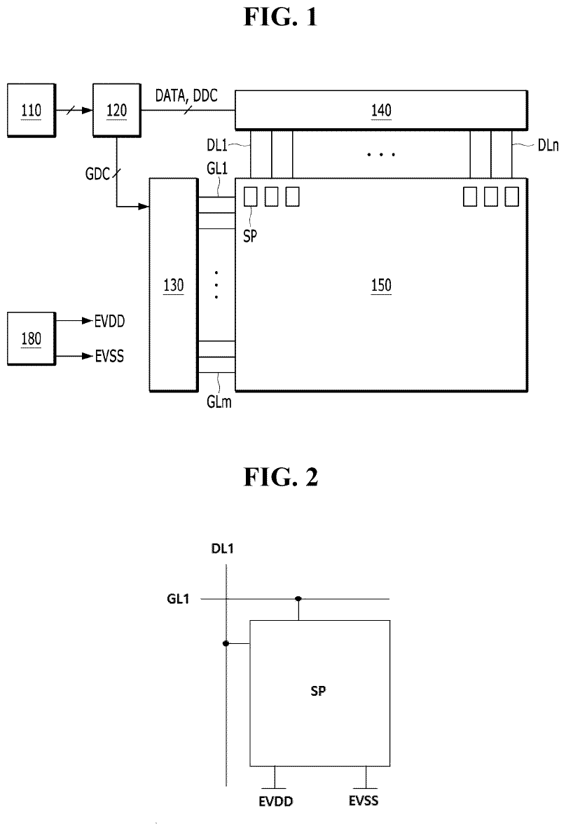

FIG. 1 is a block diagram schematically showing a light emitting display device, FIG. 2 is a configuration diagram schematically showing a subpixel shown in FIG. 1, and FIG. 3 is a diagram showing a pixel composed of subpixels.

As illustrated in FIG. 1, FIG. 2, and FIG. 3, the light emitting display device may include a timing controller 120, a gate driver 130, a data driver 140, a display panel 150, a power supply 180, and the like.

An image provider 110 (a set or a host system) may output various driving signals along with an externally supplied image data signal or an image data signal stored in an internal memory. The image provider 110 may supply data signals and various driving signals to the timing controller 120.

The timing controller 120 may output a gate timing control signal GDC for controlling the operation timing of the gate driver 130, a data timing control signal DDC for controlling the operation timing of the data driver 140, and various synchronization signals. The timing controller 120 may supply a data signal DATA supplied from the image provider 110 to the data driver 140 along with the data timing control signal DDC. The timing controller 120 may be implemented in the form of an integrated circuit (IC) and mounted on a printed circuit board, but is not limited thereto.

By way of example, the gate driver 130 outputs a gate signal (or a gate voltage) in response to the gate timing control signal GDC supplied from the timing controller 120. The gate driver 130 supplies gate signals to subpixels included in the display panel 150 through gate lines GL1 to GLm. The gate driver 130 is implemented in the form of an IC or directly formed on the display panel 150 in a gate-in-panel structure, but is not limited thereto.

By way of example, the data driver 140 samples and latch the data signal DATA in response to the data timing control signal DDC supplied from the timing controller 120, converts the digital data signal into an analog data voltage on the basis of a gamma reference voltage, and outputs the analog data voltage. The data driver 140 supplies data voltages to the subpixels included in the display panel 150 through data lines DL1 to DLn. The data driver 140 is implemented in the form of an integrated circuit (IC) and mounted on the display panel 150 or mounted on a printed circuit board, but is not limited thereto.

By way of example, the power supply 180 generates first power at a high level and second power at a low level on the basis of an external input voltage supplied from the outside. The power supply 180 outputs the first power through a first power line EVDD and output the second power through a second power line EVSS. The power supply 180 generates and output voltages (e.g., a scan high voltage and a scan low voltage) necessary to drive the gate driver 130 and voltages (e.g., a drain voltage and a half drain voltage) necessary to drive the data driver 140 as well as the first power and the second power.

By way of example, the display panel 150 displays an image in response to driving signals including a scan signal and a data voltage, the first power, and the second power. The subpixels of the display panel 150 directly emit light. The display panel 150 is manufactured based on a substrate having rigidity or flexibility, such as glass, silicon, polyimide, or the like. For example, one subpixel SP is connected to the first data line DL1, the first gate line GL1, the first power line EVDD, and the second power line EVSS and include a pixel circuit including a switching transistor, a driving transistor, a capacitor, an organic light emitting diode, etc.

Subpixels SP used in the light-emitting display device directly emit light, and thus the circuit configuration thereof is complicated. In addition, there are various compensation circuits that compensate for deterioration of not only the organic light emitting diode emitting light but also the driving transistor that supplies a driving current necessary to drive the organic light emitting diode. Therefore, the subpixel SP is simply shown in the form of a block.

Subpixels emitting light may be composed of red, green, and blue pixels or red, green, blue, and white pixels. For example, one pixel P may include a red subpixel SPR connected to the first data line DL1, a white subpixel SPW connected to the second data line DL2, a green subpixel SPG connected to the third data line DL3, and a blue subpixel SPB connected to the fourth data line DL4. Additionally, the red subpixel SPR, white subpixel SPW, green subpixel SPG, and blue subpixel SPB may be commonly connected to a first reference line VREF1. The first reference line VREF1 may be used to sense deterioration of elements included in one of the red subpixel SPR, white subpixel SPW, green subpixel SPG, and blue subpixel SPB, which will be described below.

Meanwhile, the timing controller 120, the gate driver 130, and the data driver 140 have been described as individual components. However, depending on the implementation method of the light emitting display device, one or more of the timing controller 120, the gate driver 130, and the data driver 140 may be integrated into a single IC. In addition, the timing controller 120, the gate driver 130, the data driver 140, the power supply 180, and the display panel 150 are an assembly for displaying images and may be defined as a display module.

In addition, as an example, the pixels P in which the red subpixel SPR, white subpixel SPW, green subpixel SPG, and blue subpixel SPB are arranged in order has been illustrated. However, the arrangement order and direction of subpixels may vary depending on the implementation method of the light emitting display device.

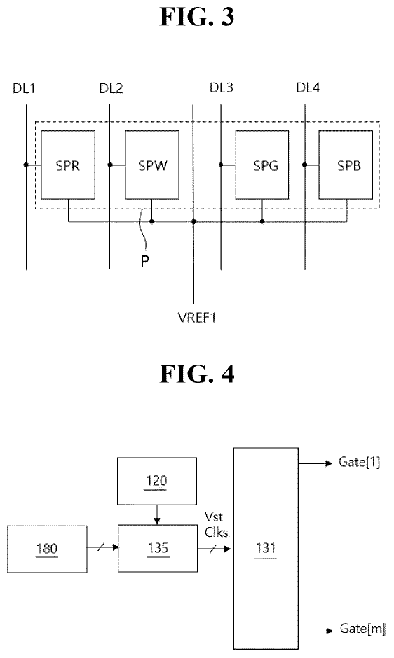

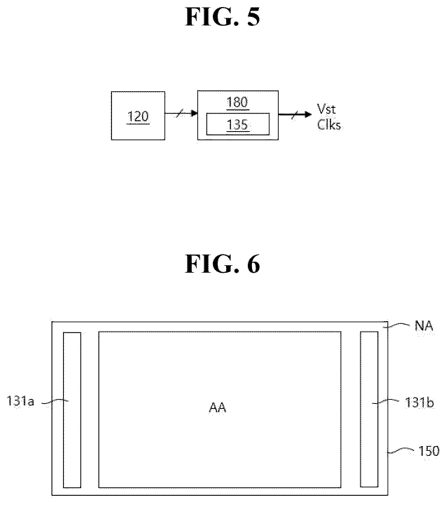

FIG. 4 and FIG. 5 are diagrams illustrating the configuration of a gate-in-panel type gate driver, and FIG. 6 is a diagram showing an example of the arrangement of the gate-in-panel type gate driver.

As shown in FIG. 4, by way of example, the gate-in-panel type gate driver includes a shift register 131 and a level shifter 135. The level shifter 135 generates driving clock signals Clks and a start signal Vst on the basis of signals and voltages output from the timing controller 120 and the power supply 180.

The shift register 131 operates on the basis of signals Clks and Vst output from the level shifter 135, and may output gate signals Gate [1] to Gate [m] for turning on or off transistors formed in the display panel. By way of example, the shift register 131 takes the form of a thin film on the display panel in a gate-in-panel structure.

As shown in FIG. 4 and FIG. 5, by way of example, unlike the shift register 131, the level shifter 135 is formed independently in the form of an IC or is included in the power supply 180. However, this is merely an example and is not limited to thereto.

As shown in FIG. 6, shift registers 131a and 131b that output gate signals in the gate-in-panel type gate driver may be disposed in a non-display area NA of the display panel 150. As an example, the shift registers 131a and 131b are disposed in the left and right non-display areas NA of the display panel 150, but the shift registers 131a and 131b may also be disposed in upper and lower non-display areas NA of the display panel 150 or may be disposed within a display area AA of the display panel 150.

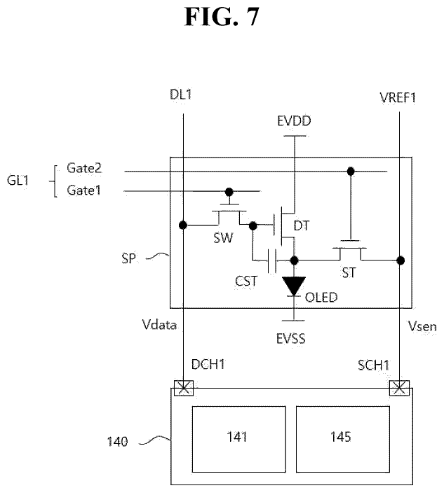

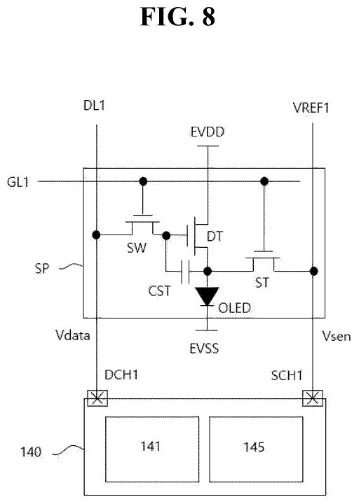

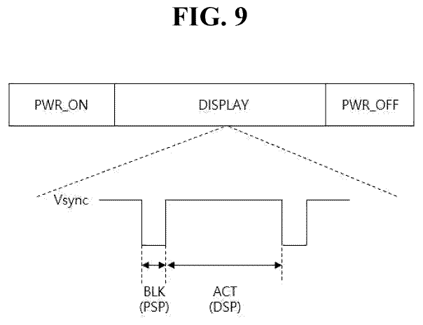

FIG. 7 is a diagram schematically showing a subpixel and a data driver according to a first example of an embodiment, FIG. 8 is a diagram schematically showing a subpixel and a data driver according to a second example of the embodiment, and FIG. 9 is a waveform diagram illustrating a sensing period and a display period.

As shown in FIG. 7, according to the first example, one subpixel SP includes a switching transistor SW, a driving transistor DT, a sensing transistor ST, a capacitor CST, and an organic light emitting diode OLED.

By way of example, the driving transistor DT includes a gate electrode connected to a first electrode of the capacitor CST, a first electrode connected to the first power line EVDD, and a second electrode connected to the anode of the organic light emitting diode OLED. The capacitor CST has the first electrode connected to the gate electrode of the driving transistor DT and a second electrode connected to the anode electrode of the organic light emitting diode OLED. The organic light emitting diode OLED has the anode connected to the second electrode of the driving transistor DT and a cathode connected to the second power line EVSS.

By way of example, the switching transistor SW includes a gate electrode connected to a first scan line Gate1 included in the first gate line GL1, a first electrode connected to the first data line DL1, and a second electrode connected to the gate electrode of the driving transistor DT. The sensing transistor ST includes a gate electrode connected to a second scan line Gate2 included in the first gate line GL1, a first electrode connected to the first reference line VREF1, and a second electrode connected to the anode of the organic light emitting diode OLED.

The sensing transistor ST is a kind of compensation circuit added to compensate for deterioration (in the threshold voltage, mobility, etc.) of the driving transistor DT or the organic light emitting diode OLED. The sensing transistor ST enables physical threshold voltage sensing based on the source follower operation of the driving transistor DT. The sensing transistor ST operates to acquire a sensing voltage Vsen through a sensing node defined between the driving transistor DT and the organic light emitting diode OLED.

According to an embodiment, the data driver 140 includes a driving circuit 141 for driving the subpixel SP and a sensing circuit 145 for sensing the subpixel SP. The driving circuit 141 is connected to the first data line DL1 through a first data channel DCH1. The driving circuit 141 outputs a data voltage Vdata for driving the subpixel SP through the first data channel DCH1.

By way of example, the sensing circuit 145 is connected to the first reference line VREF1 through a first sensing channel SCH1. The sensing circuit 145 acquires a sensing voltage Vsen sensed from the subpixel SP through the first sensing channel SCH1. The sensing circuit 145 acquires the sensing voltage Vsen based on a current sensing or voltage sensing method.

As shown in FIG. 8, according to the second example, the first gate line GL1 is integrated into one. That is, unlike the first example, the first gate line GL1 is not divided into the first scan line and the second scan line. In this case, the switching transistor SW and the sensing transistor ST are commonly connected to the first gate line GL1, and thus are turned on or off at the same time.

As shown in FIG. 9, the light emitting display device according to the embodiment adopts driving modes respectively corresponding to a first driving period PWR_ON, a second driving period DISPLAY, and a third driving period PWR_OFF when operating to drive the display panel.

By way of example, the first driving period PWR_ON corresponds to a driving start period in which power is applied to the display panel, the second driving period DISPLAY corresponds to a panel driving period in which an operation such as displaying an image is performed after the power is applied to the display panel, and a third driving period PWR_OFF corresponds to a driving end period in which the power applied to the display panel is cut off. Meanwhile, the third driving period PWR_OFF is a period in which the display panel is driven for a certain period of time while displaying black such that the sensing operation of the display panel can be performed. That is, note that the power applied to the display panel and the like is not completely cut off during the third driving period PWR_OFF.

The light emitting display device according to the embodiment senses the display panel in at least one of the first drive period PWR_ON, the second drive period DISPLAY, and the third drive period PWR_OFF. As an example, in the second driving period DISPLAY, a blank period BLK included in the vertical synchronization signal Vsync may be defined as a sensing period PSP, and an active period ACT included in the vertical synchronization signal Vsync may be defined as a display period DSP. The light emitting display device according to the embodiment can sense deterioration of the element(s) included in the subpixels of the display panel during the second driving period DISPLAY in real time.

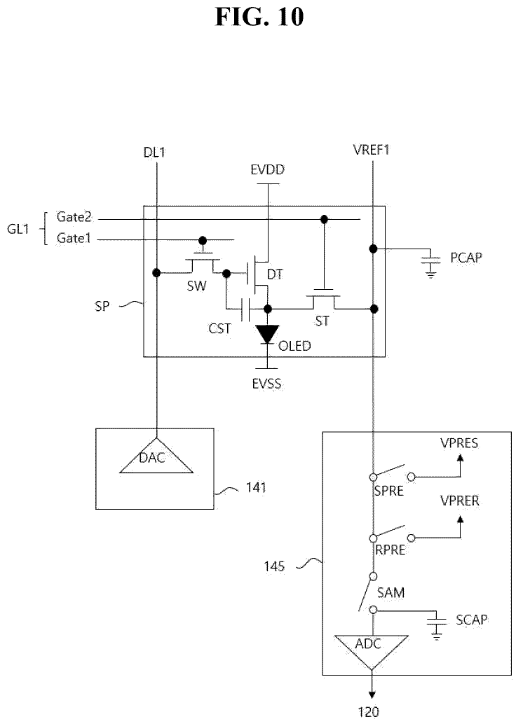

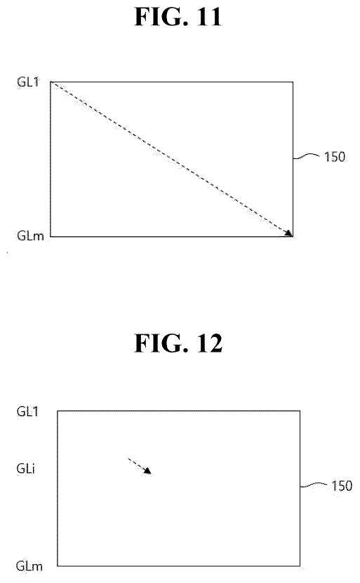

FIG. 10 is a diagram showing some of the components included in the data driver according to an embodiment in more detail, and FIG. 11 and FIG. 12 are diagrams showing a method of sensing the display panel according to the embodiment. Hereinafter, as an example, the structure of the subpixel SP shown in FIG. 7 will be described.

As in the embodiment shown in FIG. 10, by way of example, the driving circuit 141 includes a digital-to-analog converter DAC that outputs a sensing data voltage, a black data voltage, or a display data voltage through the first data line DL1. The sensing circuit 145 includes a first voltage circuit SPRE, a second voltage circuit RPRE, a sampling circuit SAM, and an analog-to-digital converter ADC that outputs and sense a voltage through the first reference line VREF1.

By way of example, the first voltage circuit SPRE and the second voltage circuit RPRE perform a voltage output operation to initialize nodes or circuits included in the subpixel SP or charge the same to a specific voltage level. The first voltage circuit SPRE and the second voltage circuit RPRE include a first reference voltage source VPRES and a second reference voltage source VPRER, respectively. The first voltage circuit SPRE outputs a first reference voltage on the basis of the first reference voltage source VPRES, and the second voltage circuit RPRE outputs a second reference voltage on the basis of the second reference voltage source VPRER. The first reference voltage is set to a voltage lower than the second reference voltage.

By way of example, the sampling circuit SAM performs a sampling operation that acquires a sensing voltage through the first reference line VREF1. For example, the sampling circuit SAM acquires the sensing voltage from a sensing capacitor PCAP formed on the first reference line VREF1 on the basis of the sensing capacitor PCAP.

The analog-to-digital converter ADC converts the analog sensing voltage acquired by the sampling circuit SAM into a digital sensing voltage and output the same. For example, the analog-to-digital converter ADC converts the analog sensing voltage charged in the sensing capacitor PCAP into a digital sensing voltage and output the same.

By way of example, the timing controller 120 receives a sensing voltage (sensing data value) from the sensing circuit 145. The timing controller 120 determines whether the driving transistor DT or the organic light emitting diode OLED included in the subpixel SP has deteriorated on the basis of the sensing voltage and perform an operation for compensating for the deterioration. Additionally, the timing controller 120 determines presence or absence of a defect in the light emitting display device on the basis of the sensing voltage and perform an operation for notifying of or removing the defect.

As shown in FIG. 11, according to the first example, by way of example, the light emitting display device performs a sequential sensing method in which sensing is performed from the first gate line GL1 to the M-th gate line GLm of the display panel 150. Although FIG. 11 illustrates an example in which sensing is performed sequentially starting from the first gate line GL1, which is the top of the display panel 150, sensing may start from the M-th gate line GLm, which is the bottom of the display panel 150.

As shown in FIG. 12, according to the second example, by way of example, the light emitting display device performs a random sensing method in which only an I-th gate line GLi of the display panel 150 is sensed. Although FIG. 12 illustrates an example in which only the I-th gate line GLi, which is one of specific gate lines, is sensed, the sensing target may be two or more gate lines.

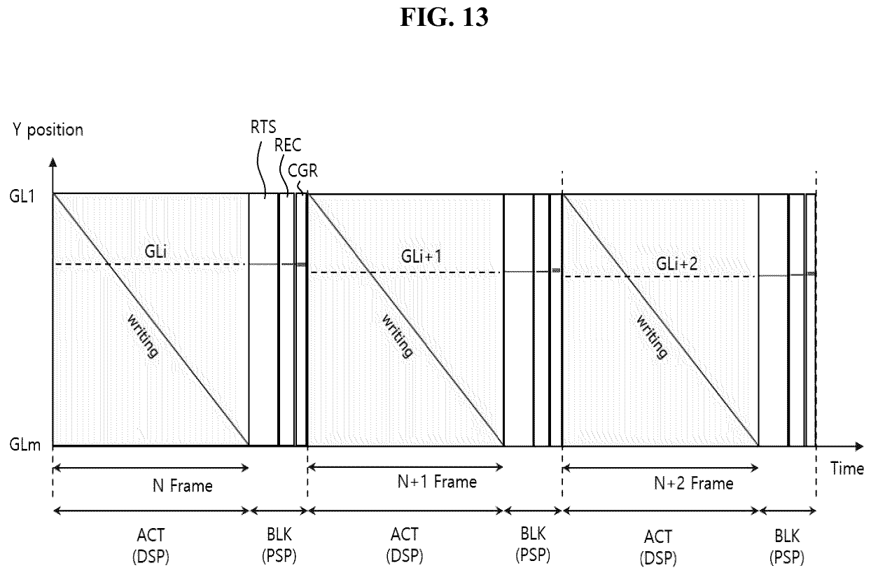

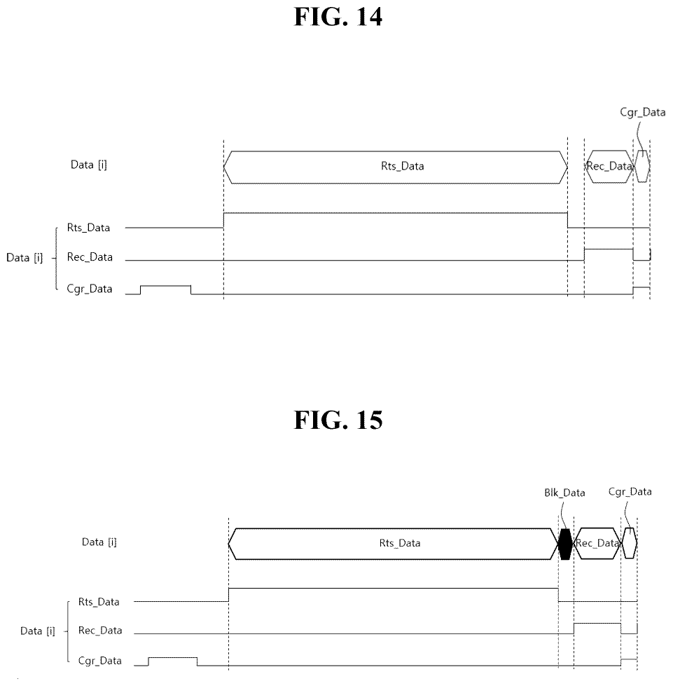

FIG. 13 is a timing diagram schematically illustrating a method of driving a light emitting display device according to an embodiment, FIG. 14 is a first example diagram showing data voltages applied to a sensing subpixel in the N-th frame shown in FIG. 13, and FIG. 15 is a second example diagram showing data voltages applied to the sensing subpixel in the N-th frame shown in FIG. 13.

As shown in FIG. 13, by way of example, in the method of driving a light emitting display device according to the embodiment, an operation of writing a display data voltage is performed during a display period DSP defined in an active period ACT and sequentially a sensing operation RTS, a recovery operation REC, and a buffering operation CGR are performed during a sensing period PSP defined in a blank period BLK.

By way of example, the sensing operation RTS is an operation that applies a sensing data voltage or the like for sensing a subpixel located on a gate line. The sensing data voltage is selected as a first data voltage by which elements included in the subpixel are detected.

By way of example, the recovery operation REC is an operation that applies a recovery data voltage or the like to a sensing target subpixel. The recovery data voltage is selected as a second data voltage identical to or higher in level than a display data voltage applied to the sensing target subpixel during the previous frame.

By way of example, the buffering operation CGR is an operation that applies a buffering data voltage or the like to reduce the difference between the recovery data voltage and the display data voltage. The buffering data voltage is selected as a third data voltage having a level between the recovery data voltage applied to the sensing target subpixel and the display data voltage (display data voltage applied to the sensing target subpixel during the next frame).

By way of example, during the sensing period PSP, the sensing data voltage, the recovery data voltage, and the buffering data voltage are sequentially applied to the data line of the sensing target subpixel.

Meanwhile, FIG. 13 illustrates an example in which the sensing period PSP is present in the blank period BLK included in each of the N-th frame, (N+1)-th frame, and (N+2)-th frame. In addition, an example in which a subpixel located on an I-th gate line GLi is sensed during the blank period BLK after the N-th frame (N Frame), a subpixel located on an (1+1)-th gate line GLi+1 is sensed during the blank period BLK after the (N+1)-th frame (N+1 Frame), and a subpixel located on an (1+2)-th gate line GLi+2 is sensed during the blank period BLK after the (N+2)-th frame (N+2 Frame) is illustrated. However, this is merely an example, and a subpixel located on one gate line may be repeatedly sensed during the blank periods BLK included in the N-th frame to the (N+2) frame.

As shown in FIG. 13 and FIG. 14, by way of example, during the blank period BLK after the N-th frame (N Frame), a data voltage Data [i] output through the I-th channel of the data driver is applied to the sensing target subpixel in the I-th gate line GLi. The data voltage Data [i] output through the I-th channel is applied to the sensing target subpixel in the I-th gate line GLi through the I-th data line.

By way of example, the data voltage Data [i] output through the I-th channel of the data driver includes a sensing data voltage Rts_Data used for the sensing operation RTS, a recovery data voltage Rec_Data used for the recovery operation REC, and a buffering data voltage Cgr_Data used for the buffering operation CGR. The sensing target subpixel receives the sensing data voltage Rts_Data, the recovery data voltage Rec_Data, and the buffering data voltage Cgr_Data in order.

As shown in FIG. 13 and FIG. 15, by way of example, a black data voltage Blk_Data is included between the sensing data voltage Rts_Data and the recovery data voltage Rec_Data supplied through the I-th data line Data [i]. The black data voltage Blk_Data serves to reduce interference between the sensing data voltage Rts_Data and the recovery data voltage Rec_Data and to initialize the I-th data line Data [i] (to cause the sensing target subpixel to be in a non-display state).

Meanwhile, the method of applying the buffering data voltage Cgr_Data between the recovery data voltage Rec_Data and the display data voltage applied to the next frame and the resulting effects will be described in more detail below.

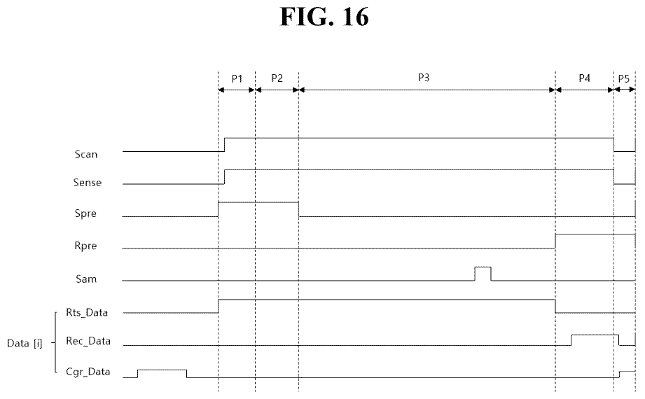

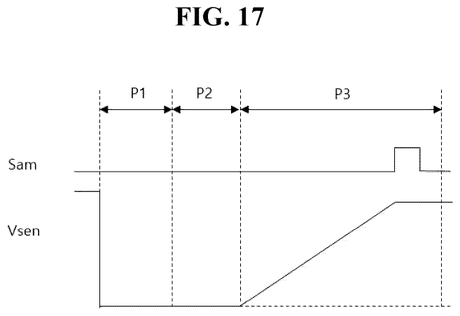

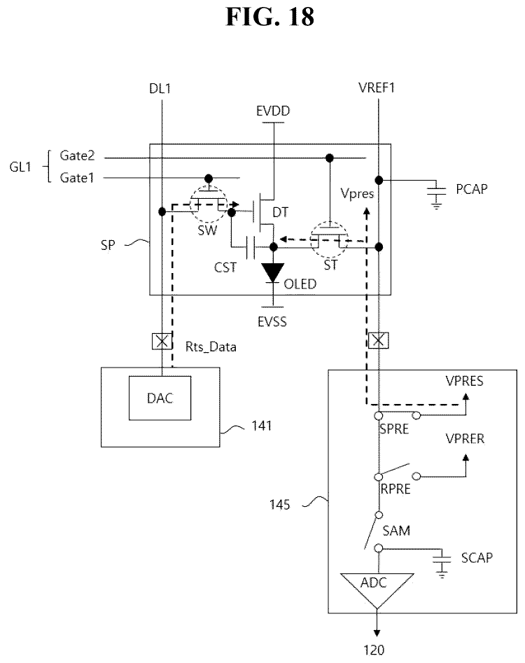

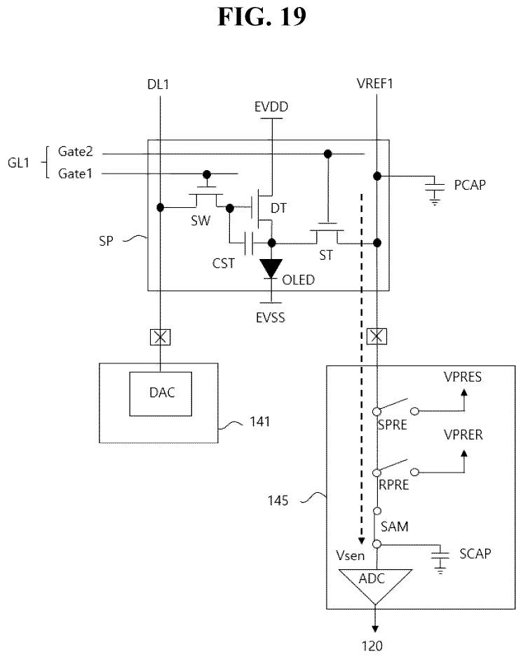

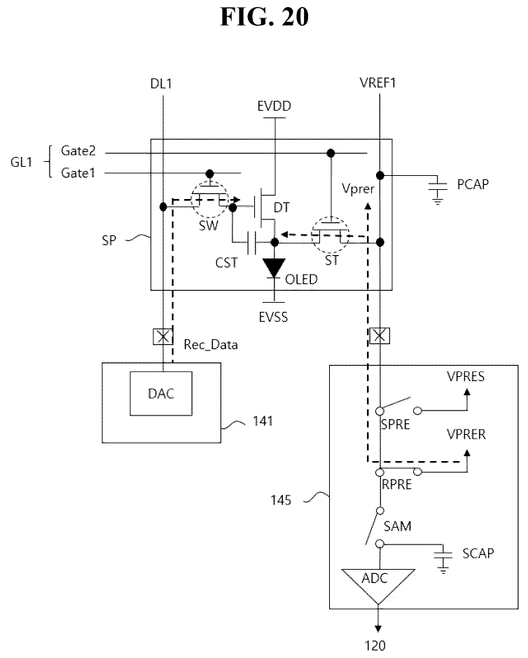

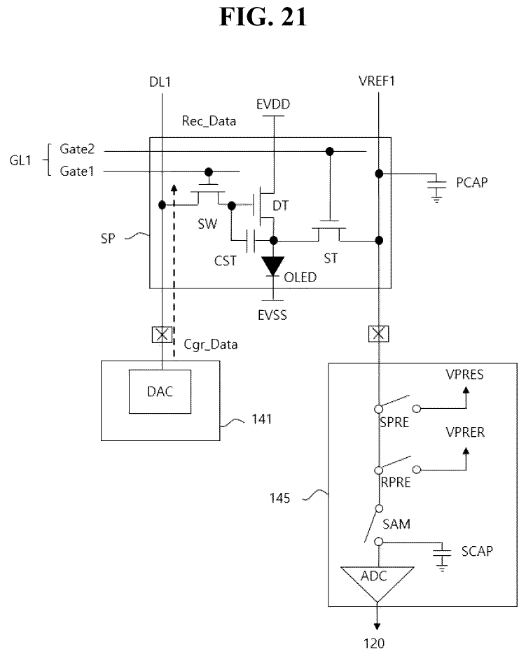

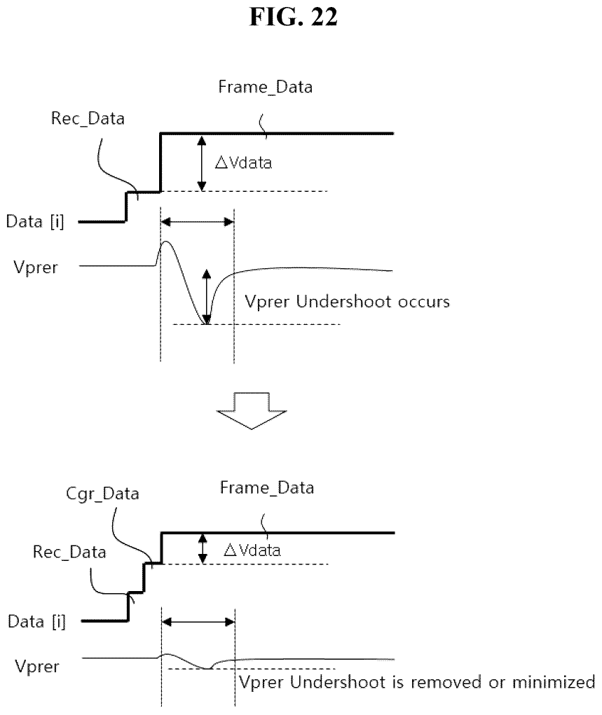

FIG. 16 is a timing diagram illustrating the method of driving a light emitting display device according to the embodiment in more detail, FIG. 17 is a diagram illustrating a sensing voltage obtained through sensing illustrated in FIG. 16, FIG. 18 to FIG. 21 are diagrams showing step-by-step operations of main devices according to the driving method shown in FIG. 16, and FIG. 22 is a diagram illustrating differences depending on whether or not a buffering data voltage is applied.

As shown in FIG. 16, by way of example, in the method of driving a light emitting display device according to the embodiment, a first period P1, a second period P2, a third period P3, a fourth period P4, and a fifth period P5 are included in order in a sensing period.

By way of example, the first period P1 is an initialization period, the second period P2 is defined as a programming period, the third period P3 is a sensing and sampling period, the fourth period P4 is an initialization and recovery period, and the fifth period P5 is a buffering period. Hereinafter, an example in which a subpixel located on the I-th gate line GLi is a sensing target will be described.

As shown in FIG. 16 and FIG. 18, by way of example, during the first period P1 to the fourth period P4, the switching transistor SW and the sensing transistor ST are turned on based on a scan signal Scan and a sensing signal Sense is applied to the first scan line Gate1 and the second scan line Gate2.

By way of example, the data driver outputs the sensing data voltage Rts_Data through the I-th channel during the first period P1 to the third period P3. The first voltage circuit SPRE outputs the first reference voltage Vpres through the first reference line VREF1 in response to a first voltage output signal Spre during the first period Pl and the second period P2. Accordingly, the gate electrode node of the driving transistor DT is charged by the sensing data voltage Rts_Data, and the source electrode node (sensing node) of the driving transistor DT is charged by the first reference voltage Vpres. At this time, the driving transistor DT is initialized by the sensing data voltage Rts_Data and the first reference voltage Vpres.

As shown in FIG. 16, FIG. 17, and FIG. 19, by way of example, the sampling circuit SAM obtains the sensing voltage Vsen through the first reference line VREF1 in response to a sampling signal Sam during the third period P3. The sampling circuit SAM obtains the sensing voltage Vsen from the sensing capacitor PCAP formed on the first reference line VREF1 based on the sensing capacitor PCAP.

As shown in FIG. 16 and FIG. 20, by way of example, the data driver outputs the recovery data voltage Rec_Data through the I-th channel during the fourth period P4. The second voltage circuit RPRE outputs the second reference voltage Vprer through the first reference line VREF1 in response to a second voltage output signal Rpre during the fourth period P4. Accordingly, the gate electrode node of the driving transistor DT is charged by the recovery data voltage Rec_Data, and the source electrode node (sensing node) of the driving transistor DT is charged by the second reference voltage Vprer. At this time, the driving transistor DT is recovered by the recovery data voltage Rec_Data and the second reference voltage Vprer.

By way of example, the recovery data voltage Rec_Data is selected as a voltage that compensates for a difference from the display data voltage applied before the sensing period can be reduced or a decrease in the luminance of the sensing target subpixel. Additionally, the recovery data voltage Rec_Data is selected as a voltage that compensates for a data voltage charging (holding) time difference which varies depending on the position of a sensing line such that a selected sensing line is not visible during the sensing period. Additionally, the recovery data voltage Rec_Data is selected as a voltage that compensates for the difference between a sensing line and a non-sensing line. Additionally, the recovery data voltage Rec_Data is selected as a voltage that compensates for a data voltage charging (holding) time difference due to a variation in a vertical blank time when a frame rate is varied.

As shown in FIG. 16 and FIG. 21, by way of example, the data driver outputs the buffering data voltage Cgr_Data through the I-th channel during the fifth period P5. The buffering data voltage Cgr_Data is charged in the first data line DL1 connected to the sensing target subpixel. The buffering data voltage Cgr_Data serves to reduce the voltage difference from the display data voltage (the display data voltage applied to the next frame) applied after the recovery operation using the recovery data voltage Rec_Data.

As shown in FIG. 22, by way of example, the buffering data voltage Cgr_Data serves to alleviate the coupling phenomenon between the second reference voltage Vprer and the data voltage Frame_Data which is caused in the process of transition from the recovery data voltage Rec_Data to the display data voltage (display data voltage Frame_Data applied to the next frame).

Before the buffering data voltage Cgr_Data is applied, by way of example, a high voltage difference AVdata occurs between the recovery data voltage Rec_Data and the display data voltage (display data voltage Frame_Data applied to the next frame). As a result, undershoot (Vprer Undershoot) of the second reference voltage occurs due to the coupling phenomenon between the second reference voltage Vprer and the data voltage Frame_Data.

However, after the buffering data voltage Cgr_Data is applied, by way of example, a relatively low voltage difference AVdata occurs between the recovery data voltage Rec_Data and the display data voltage (display data voltage Frame_Data applied to the next frame). Accordingly, even if the coupling phenomenon occurs between the second reference voltage Vprer and the data voltage Frame_Data, undershoot (Vprer Undershoot) of the second reference voltage is eliminated or minimized.

As can be ascertained from this, by way of example, it is desirable that the buffering data voltage Cgr_Data takes a step data voltage form such that problems caused by the voltage difference AVdata between the recovery data voltage Rec_Data and the display data voltage Frame_Data applied to the next frame are mitigated/alleviated.

Meanwhile, FIG. 22 shows an example in which the buffering data voltage Cgr_Data between the recovery data voltage Rec_Data and the display data voltage Frame_Data forms a step. However, the buffering data voltage Cgr_Data is applied in the form of a step voltage (a voltage whose voltage level gradually increases stepwise) such that the buffering data voltage Cgr_Data forms multiple stairs together with the recovery data voltage Rec_Data and the display data voltage Frame_Data.

As in the embodiment, when the buffering data voltage Cgr_Data is applied between the recovery data voltage Rec_Data and the display data voltage Frame_Data, not only the coupling phenomenon between the second reference voltage Vprer and the data voltage Frame_Data but also problems caused by overcompensation and undercompensation depending on luminance are minimized/improved.

In addition, when the buffering data voltage Cgr_Data is applied between the recovery data voltage Rec_Data and the display data voltage Frame_Data, problems that sensing lines are visible or luminance differences (including luminance reduction) occur are minimized/improved since a non-emission time according to the sensing target subpixel is provided.

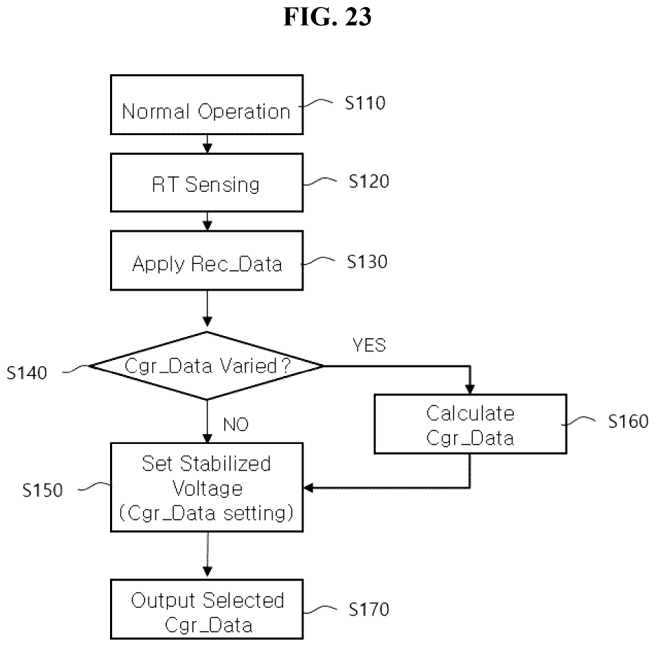

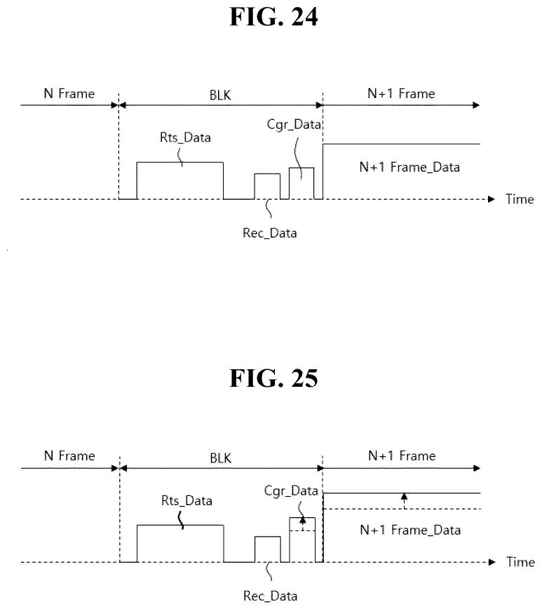

FIG. 23 is a flowchart illustrating a method of configuring a buffering data voltage according to an embodiment, and FIG. 24 and FIG. 25 are diagrams showing a buffering data voltage that varies based on the level of a display data voltage applied to the next frame according to an embodiment.

As shown in FIG. 23, by way of example, the buffering data voltage is applied as a determined voltage value (fixed value) to stabilize the operation of the light emitting display device, or is applied as a variable voltage value (variable value) through calculation, which will be described below.

By way of example, the light emitting display device performs a normal operation to display an image through the display panel (S110), and then performs a sensing operation (RT Sensing) that compensates for subpixels located on a specific sensing line in response to a determined setting value (S120). The recovery data voltage Rec_Data is applied during the sensing operation (RT Sensing) (S130). The method of applying the recovery data voltage Rec_Data along with the sensing operation (RT Sensing) are performed as described with reference to FIG. 13 to FIG. 21, but is not limited thereto.

During the sensing operation (RT Sensing), by way of example, the recovery data voltage Rec_Data is applied and then whether the buffering data voltage Cgr_Data is to be varied is determined (S140). If it is not necessary to vary the buffering data voltage Cgr_Data (NO), setting of stabilized reference voltages (e.g., Vprer and Vpres) including the buffering data voltage Cgr_Data is completed (S150).

On the other hand, if the buffering data voltage (Cgr_Data) needs to be varied (YES), an operation is performed to calculate the level of the buffering data voltage Cgr_Data (S160), setting of stabilized reference voltages is completed (S150), and then a selected buffering data voltage Cgr_Data is output (S170). The buffering data voltage Cgr_Data is calculated on the basis of a reference voltage (e.g., Vprer or Vpres) that reflects the characteristics of each display panel through a pre-sensing process of display panels. The calculated buffering data voltage Cgr_Data can be stored in a storage device such as a register such that it can be extracted and used when necessary.

As shown in FIG. 23 to FIG. 25, in the calculation process for calculating the level of the buffering data voltage Cgr_Data, an example in which the voltage value is adjusted on the basis of the level of a display data voltage N+1 Frame_Data applied to the next frame is illustrated. For reference, FIG. 25 shows an example in which the level of the buffering data voltage Cgr_Data increases as the level of the display data voltage N+1 Frame_Data applied to the next frame increases as compared to FIG. 24.

However, the level of the buffering data voltage Cgr_Data can be calculated in consideration of all of the various conditions described above. In addition, the calculation process for calculating the level of the buffering data voltage Cgr_Data is performed by the timing controller, but is not limited thereto.

Meanwhile, an example in which the data driver outputs both the recovery data voltage and the buffering data voltage in addition to the sensing data voltage during the sensing period has been described above. However, the data driver may output only the sensing data voltage to the sensing target subpixel in response to an output method calculated in advance on the basis of the difference between the display data voltage applied to the previous frame and the display data voltage to be applied to the next frame. That is, if the difference between the display data voltage applied to the previous frame and the display data voltage to be applied to the next frame is insignificant or recovery is unnecessary, output of the recovery data voltage and the buffering data voltage may be omitted.

As described above, the present disclosure has the effect of mitigating or alleviating problems caused by the difference between a recovery data voltage and a display data voltage applied to the next frame during a sensing period (or blank period) for sensing deterioration of elements included in a subpixel. In addition, the present disclosure has the effect of minimizing or improving the coupling phenomenon between different voltages and problems caused by overcompensation and undercompensation depending on luminance by writing a buffering data voltage between the recovery data voltage and the display data voltage applied to the next frame. Further, the present disclosure has the effect of minimizing or improving problems that sensing lines are visible or luminance differences (including luminance decrease) occur since a non-emission time according to a sensing target subpixel is provided.

It will be apparent to those skilled in the art that various modifications and variations can be made in the present disclosure without departing from the spirit or scope of the present disclosure. Thus, it is intended that the present disclosure cover the modifications and variations of the present disclosure provided they come within the scope of the appended claims and their equivalents.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device, comprising:
a display panel including a plurality of subpixels; and
a data driver connected to the display panel,
wherein the data driver, in operation, outputs a plurality of data voltages for displaying an image based on the subpixels during a driving period of the display panel, and outputs a first data voltage, a second data voltage, and a third data voltage during a sensing period of the display panel,
wherein a level of the first data voltage is different from a level of the second data voltage, and
wherein the level of the second data voltage is different from a level of the third data voltage.

2. The display device of claim 1, wherein the level of the second data voltage is equal to or higher than a level of a display data voltage applied to a sensing target subpixel during a previous frame.

3. The display devi-ce of claim 1, wherein the level of the third data voltage is between the level of the second data voltage and a level of a display data voltage to be applied to a sensing target subpixel during a next frame.

4. The display device of claim 1, wherein the first data voltage is a sensing data voltage for sensing a sensing target subpixel during the sensing period of the display panel,
wherein the second data voltage is a recovery data voltage that compensates for a decrease in luminance of the sensing target subpixel during the sensing period of the display panel, and
wherein the third data voltage is a buffering data voltage that reduces a difference between a level of a display data voltage to be applied to the sensing target subpixel during the sensing period of the display panel and a level of a display data voltage to be applied to the sensing target subpixel during a next frame.

5. The display device of claim 1, wherein the first data voltage, the second data voltage, and the third data voltage form a step voltage having a level that gradually increases in a step shape.

6. The display device of claim 1, wherein the third data voltage varies in response to a level of a display data voltage to be applied to a sensing target subpixel.

7. A display device, comprising:
a display panel including a plurality of subpixels; and
a data driver connected to the display panel,
wherein the data driver, in operation, sequentially outputs a first data voltage, a second data voltage, and a third data voltage through a data line connected to the display panel during a blank period,
wherein a level of the first data voltage is different from a level of the second data voltage, and
wherein the level of the second data voltage is different from a level of the third data voltage.

8. The display device of claim 7, wherein the level of the second data voltage is equal to or higher than a level of a display data voltage applied to a sensing target subpixel during a previous frame.

9. The display device of claim 7, wherein the level of the third data voltage is between the level of the second data voltage and a level of a display data voltage to be applied to a sensing target subpixel during a next frame.

10. The display device of claim 7, wherein the first data voltage is a sensing data voltage for sensing a sensing target subpixel during a sensing period of the display panel,
the second data voltage is a recovery data voltage that compensates for a decrease in luminance of the sensing target subpixel during the sensing period of the display panel, and
the third data voltage is a buffering data voltage that reduces a difference between a level of a display data voltage to be applied to the sensing target subpixel during the sensing period of the display panel and a level of a display data voltage to be applied to the sensing target subpixel during a next frame.

11. The display device of claim 7, wherein the first data voltage, the second data voltage, and the third data voltage form a step voltage having a level that gradually increases in a step shape.

12. The display device of claim 7, wherein the level of the third data voltage varies in response to a level of a display data voltage to be applied to a sensing target subpixel.

13. A method of driving a display device, comprising:
outputting a plurality of data voltages for displaying an image based on a plurality of subpixels during a driving period of a display panel;
outputting a first data voltage for sensing a sensing target subpixel during a sensing period of the display panel;
outputting a second data voltage that compensates for a decrease in luminance of the sensing target subpixel during the sensing period of the display panel; and
outputting a third data voltage that reduces a difference between a level of a data voltage to be applied to the sensing target subpixel during the sensing period of the display panel and a level of a data voltage to be applied to the sensing target subpixel during a next frame.

14. The method of claim 13, wherein the first data voltage, the second data voltage, and the third data voltage form a step voltage having a level that gradually increases in a step shape.

15. The method of claim 13, further comprising:
varying a level of the third data voltage in response to a level of a display data voltage to be applied to the sensing target subpixel.
